(19) United States
(12) Patent Application Publication
(10) Pub. No.: US 2021/0149420 A1
(43) Pub. Date: May 20, 2021

(54) PROCESSES FOR SAVING FUEL FOR AN AIRCRAFT FLIGHT

(71) Applicant: Airbus SAS, Blagnac (FR)

(72) Inventors: Imad LEBBOS, Blagnac (FR); Daniel PERCY, Blagnac (FR)

(21) Appl. No.: 16/951,887

(22) Filed: Nov. 18, 2020

Related U.S. Application Data
(60) Provisional application No. 62/937,493, filed on Nov. 19, 2019.

(51) Int. Cl. G05D 1/10; H04W 4/46; G08G 5/00

(52) U.S. Cl. CPC G05D 1/104; G08G 5/0039; H04W 4/46

(57) ABSTRACT

A process for pairing two aircraft together to save fuel. After evaluating whether two aircraft may possibly be paired together in a formation for fuel savings, the process determines a new flight plan for the second, or follower, aircraft wherein the second aircraft flies behind the first aircraft to take advantage of the energy of the wake vortices generated by the first aircraft. Based on the new flight plan, the process determines if there is a trip fuel savings for a follower aircraft, and thus the pair.

### RELATED APPLICATIONS

This application claims priority to U.S. Provisional Patent Application No. 62/937,493 filed on Nov. 19, 2019, the entirety of which is incorporated herein by reference.

### BACKGROUND

An aircraft in flight generates two wake vortices in its wake—one from each of the wings. From the wings, these wake vortices first tend to move closer to each other, then maintain a more or less constant distance between them while losing altitude in relation to the altitude at which they were generated.

In a known manner, the position of the centers, as well as the circulation strengths of the vortices, generated by an aircraft can be calculated from flight parameters of the aircraft such as the mass, the altitude, the roll angle, the aerodynamic configuration, span, air density at the point of flight, speed, etc.

It may be beneficial for a second aircraft, which will be called a follower aircraft, to be able to calculate the positions of the wake vortex centers generated by a first or leader aircraft, in order to fly in formation behind the leading aircraft in the upwash region of the trailing vortices, and to take advantage of their energy, and thus reduce its fuel consumption.

It is believed that the second aircraft wishing to benefit from the wake vortices of the leading aircraft must be within three (3) nautical miles (“NM”) behind the leading aircraft.

Currently, devices exist which are known for calculating the circulation strength of wake vortices generated by a leading aircraft in order to allow a follower aircraft to know the distribution of the upward winds generated relative to the center of a vortex, and thus to take a position so as to take advantage effectively of the vortices.

However, it is believed that there are no devices or methods for bringing a potentially following aircraft from its initial point of flight and arranging it behind a leader aircraft to form a fuel saving formation.

This may be due to the fact that aircraft flight plans are determined in advance and filed by airlines before the appropriate government authorities. Also, it is unusual for a pilot to significantly modify a flight plan once it has been deposited with the competent authorities (ATC, . . . ). A further difficulty lies in the determination of possible pairs (leader-follower) because of the number of airplanes in the air at the same time, with different routes, different directions, and the choice of pairs that have an interest in terms of fuel savings. For example, every day between two and three thousand aircraft fly across the North Atlantic.

Therefore, there is a need for a method and system that is able to effectively and efficiently form a pair of flights that may be able to be paired into a flight formation that generates fuel savings.

### SUMMARY OF THE INVENTION

The present invention relates to a method and a system that enables identifying, assessing, and validating flight plan modifications to enable trip fuel savings for a potential follower aircraft by flying in formation with a leader aircraft, the latter not being required to make any deviation from its original flight plan. Generally, the present processes and systems identify, for a given flight of a commercial aircraft transporting either passengers or freight, all other possible flights (of any aircraft type) to carry out a formation flight with, in order to allow trip fuel savings for the follower aircraft compared to its original flight plan which does not include flying in formation. The invention offers strategies to enable an aircraft to meet with another aircraft and to place itself in the desired position in the wake of the latter for generating fuel savings, while also offering ways to increase the total trip fuel savings by bringing modifications to the original flight plan of the follower aircraft only. These identified flights must comply with operator preferences and are subject to validation phases by the aircraft operators and air navigation service providers. The present invention aims at having a system which enables formation flight for either cargo or passenger aircraft.

Accordingly, in a first aspect, the present invention may be generally characterized as providing a process for pairing two aircraft together to save fuel by adjusting the flight plan of one of the two aircraft by: identifying a possible pair of aircraft from a database of aircraft flight plans, the possible pair of aircraft including a leader aircraft and a follower aircraft, each having an initial flight plan; modifying the initial flight plan of the follower aircraft to provide a new flight plan, wherein the new flight plan includes a common ground section which overlaps with the initial flight plan of the leader aircraft so that the follower aircraft flies in an upwash region of the wake vortices of the leader aircraft; determining if there is a trip fuel savings associated with the possible pair of aircraft based on the follower aircraft utilizing the new flight plan instead of the initial flight plan; and, when there is a trip fuel savings, replacing the initial flight plan in the database with the new flight plan.

Identifying a possible pair of aircraft from a database of aircraft flight plans may include applying a first criteria against each possible pair of aircraft. The first criteria may include: determining that the leader aircraft and the follower aircraft are both airborne at the same time for a certain time period; or, determining that the initial flight plan of the leader aircraft and the initial flight plan of the follower aircraft have an overlapping section; or, determining that the initial flight plan of the leader aircraft and the initial flight plan of the follower aircraft have an overlapping section and that the two aircraft are not further than 300 NM apart at a beginning of the overlapping section; or, a combination thereof. The first criteria may also include: determining that the leader aircraft and the follower aircraft are both airborne at the same time for a certain time period; or, determining that the initial flight plan of the leader aircraft and the initial flight plan of the follower aircraft have the same general direction; or, determining that a maximum allowable added travel distance of 700 NM for the follower aircraft is not exceeded; or determining the two aircraft are not further than 300 NM apart at a beginning of the overlapping section whether the overlapping section is resulting from the follower aircraft's initial flight plan or the modified one; or a combination thereof. The first criteria may also include: types of the leader aircraft and the follower aircraft; or, airlines of the leader aircraft and the follower aircraft; or, airline preferences for pairing choices; or, a combination thereof.

Modifying the flight plan of the follower aircraft to provide a new flight plan may include adjusting at least one of speed and altitude to reach a point in a fuel savings formation.

Modifying the flight plan of the follower aircraft to provide a new flight plan may include adjusting a merge point, a split point, or both, the merge point representing an initial waypoint in the common ground section and the split point representing a final waypoint in the common ground section.

Determining if there is a fuel savings associated with the possible pair of aircraft based on the follower aircraft utilizing the new flight plan may include: determining takeoff weights of both the follower aircraft and the leader aircraft; determining a weight of the leader aircraft throughout the initial flight plan of the leader aircraft; determining a weight of the follower aircraft throughout the flight plan of the follower aircraft; and, determining a weight of the follower aircraft throughout the new flight plan.

The process may further include, continuously applying a second criteria between the merge and the split point and then if the second criteria is satisfied/met and there is a trip fuel savings, and replacing the initial flight plan in the database with the new flight plan. The second criteria may include continuously comparing the speed envelope of the leader aircraft with the speed envelope of the follower aircraft making sure that any given Mach number and/or altitude they fly at together is compatible with their respective flyable domains of speed and altitude.

The database may be updated automatically based on a preselected preference.

According to a second aspect, the present invention may be characterized, broadly, as providing a process for pairing two aircraft together to save fuel by adjusting a flight plan of one of the two aircraft by: identifying a possible pair of aircraft from a database of aircraft flight plans, the possible pair of aircraft including a leader aircraft and a follower aircraft, each having an initial flight plan, and each initial flight plan having a plurality of waypoints along the flight plan; modifying the initial flight plan of the follower aircraft to provide a new flight plan, wherein the new flight plan includes a common ground section which overlaps with the initial flight plan of the leader aircraft so that the follower aircraft flies in an upwash region of the wake vortices of the leader aircraft, and wherein the new flight plan includes the same waypoints as the initial flight plan of the follower aircraft; determining if there is a trip fuel savings associated with the possible pair of aircraft based on the follower aircraft utilizing the new flight plan instead of the initial flight plan; and, when there is a trip fuel savings, replacing the initial flight plan in the database with the new flight plan.

In a third aspect, the present invention may generally be characterized as providing a process for pairing two aircraft together to save fuel by adjusting a flight plan of one of the two aircraft by: identifying a possible pair of aircraft from a database of aircraft flight plans, the possible pair of aircraft including a leader aircraft and a follower aircraft, each having an initial flight plan, and each initial flight plan having a plurality of waypoints along the flight plan; modifying the initial flight plan of the follower aircraft to provide a new flight plan, wherein the new flight plan includes a common ground section which overlaps with the initial flight plan of the leader aircraft so that the follower aircraft flies in an upwash region of the wake vortices of the leader aircraft, and wherein the new flight plan includes at least one new waypoint that is not in the initial flight plan of the follower aircraft; determining if there is a trip fuel savings associated with the possible pair of aircraft based on the follower aircraft utilizing the new flight plan instead of the initial flight plan; and, when there is a trip fuel savings, replacing the initial flight plan in the database with the new flight plan. The common ground section includes a merge point at a beginning and a split point at an end, and the merge point may be based on a new waypoint from the at least one new waypoint that is not in the initial flight plan of the follower aircraft, or the split point may be based on a new waypoint from the at least one new waypoint that is not in the initial flight plan of the follower aircraft, or both.

These and other aspects and embodiments of the present invention will be appreciated by those of ordinary skill in the art based upon the following description of the drawings and detailed description of the preferred embodiments.

### DETAILED DESCRIPTION OF THE DRAWINGS

One or more exemplary embodiments of the present invention will be described below in conjunction with the following drawing figure, in which:

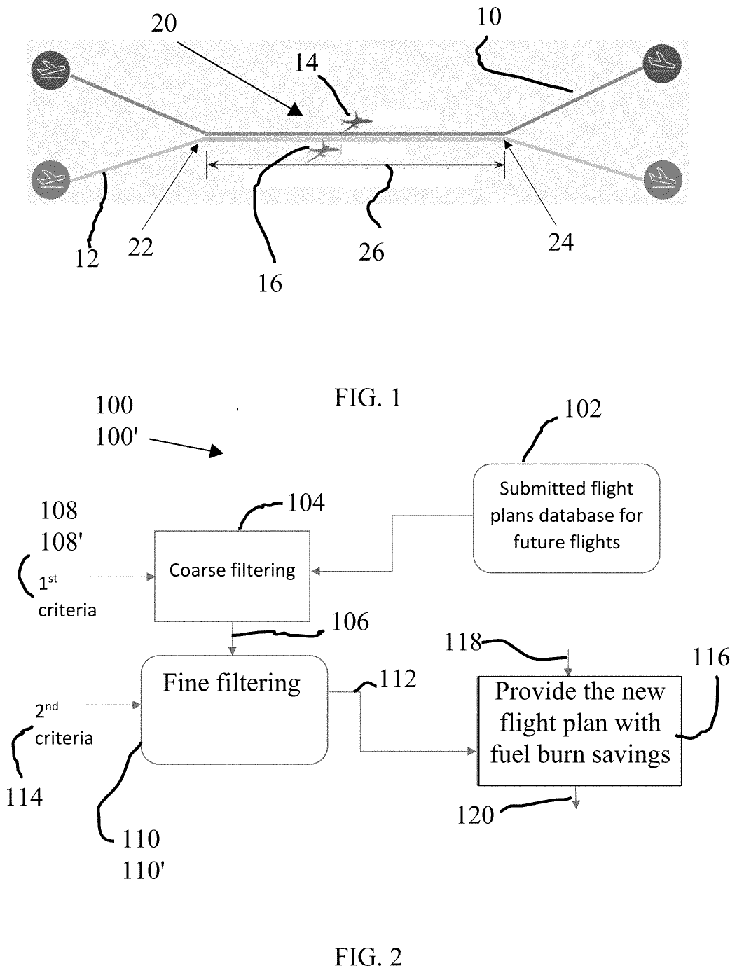

FIG. 1 is a schematic representation of two flights having flight plans that overlap that may be analyzed according to one or more embodiments of the present invention;

FIG. 2 is a process flow diagram of one or more processes according to the present invention;

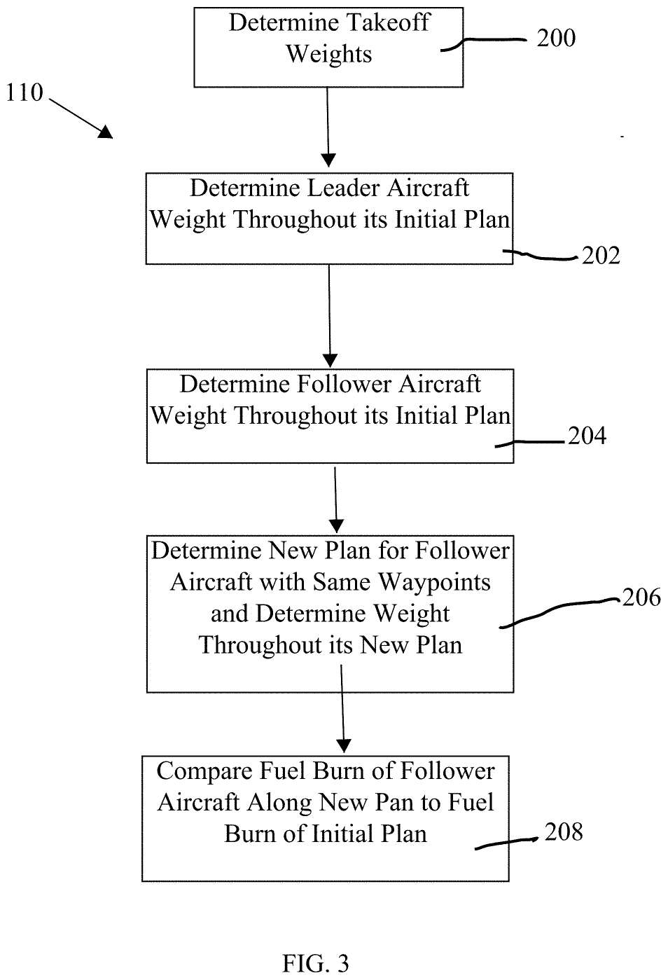

FIG. 3 is a process flow diagram of an aspect of the processes according to the present invention;

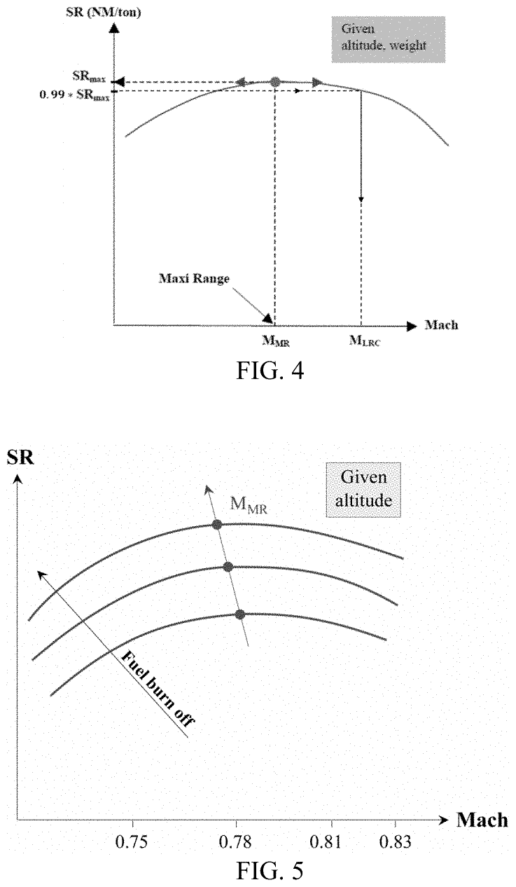

FIG. 4 is a graph illustrating the evolution of the SR criteria function of Mach number, for a given aircraft weight, aircraft configuration and a constant altitude;

FIG. 5 is a graph illustrating the SR function of Mach for different weights of a given aircraft, at a given altitude;

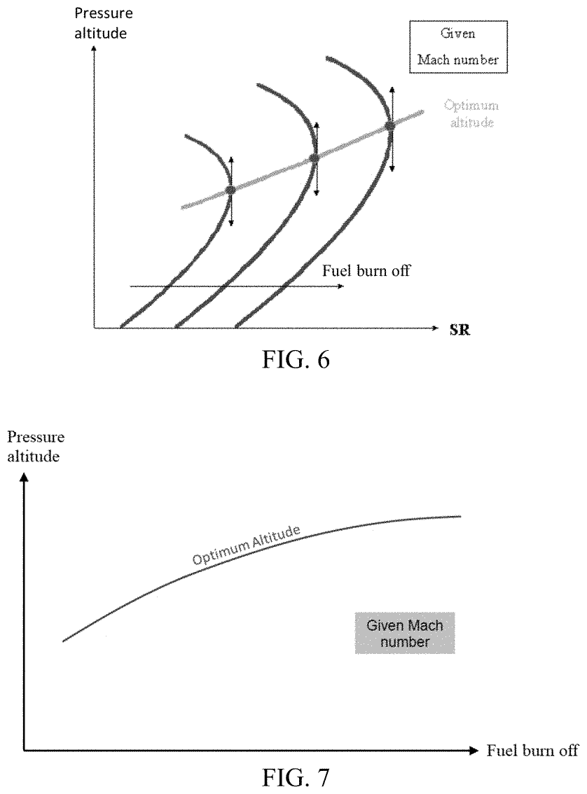

FIG. 6 is a graph illustrating for a given Mach number, the impact of Pressure Altitude (PA) on the SR curve and the evolution of the maximum SR value and the corresponding PA for a given aircraft, as it burns off fuel and loses weight;

FIG. 7 is a graph illustrating that for a given weight, there exists an altitude where SR is at a maximum which is the fuel optimum altitude, and which increases continuously during flight as the aircraft's weight decreases

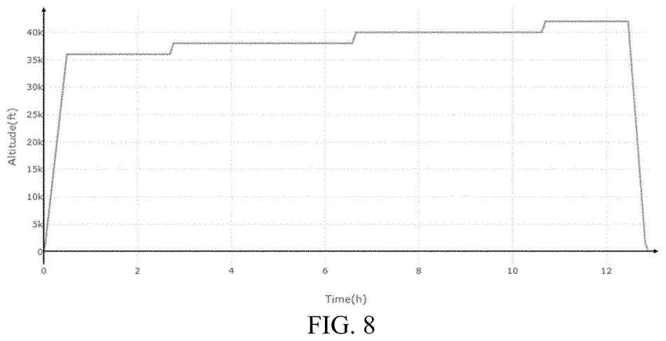

FIG. 8 is a graph illustrating an altitude profile of an aircraft flying at its optimum flight level (altitudes); and,

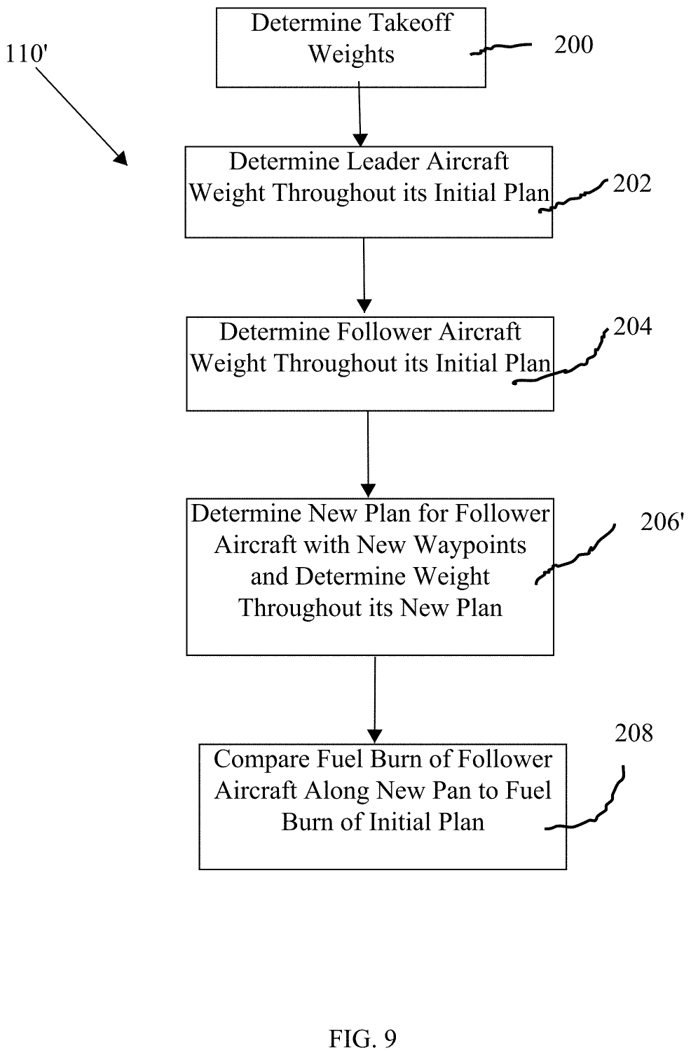

FIG. 9 is a process flow diagram of an aspect of the processes according to the present invention.

### DETAILED DESCRIPTION OF THE INVENTION

As noted above, the present invention provides processes for comparing flights to determine if there is a fuel savings by pairing the aircraft together so that a follower aircraft may utilize the wake vortices of a lead aircraft. According to the present processes, the flight plan of the leader aircraft is not adjusted for the determination—only aspects of the follower's flight plan. In some embodiments, the waypoints of the follower aircraft are kept the same and the speed and/or altitude are adjusted. In some embodiments, new waypoints are determined for the follower aircraft. If the new flight plan for the follower provides a fuel savings, the new flight plan may be used for the follower aircraft.

With these above general aspects of the present invention in mind, one or more embodiments of the present invention will be described with the understanding that the following description is not intended to be limiting.

According to the present invention, as shown in FIG. 1, the flight plans 10, 12 of two aircraft 14, 16 are utilized to provide an opportunity for fuel savings by pairing the flights 14, 16 so that a follower aircraft 16 may take advantage of the wake vortices of a leader aircraft 18. The pairing provides a formation flight 20 between a merge point 22 and a split point 24. The merge point 22 is one of the first waypoints, in both flights' cruise phases of their flight plans 10, 12, from which the ground tracks indicated in the two flight plans 10, 12 overlap one another. In other words, the merge point 22 is the start of a common section 26. The split point 24 is one of last common waypoints before either of the two aircraft 14, 16 initiates a final descent phase of its flight plan 10, 12. In other words, the split point 24 is the end of a common section 26.

The two flights 10, 12 may be planning to use the same routes to get from their departure airports to their destination airports. Their planned routes geographically overlap one another producing the common ground track section 26. On this shared route, the present process implements a fuel saving formation flight between the two aircraft 14, 16, one playing the role of the leader aircraft 14 while the other plays the role of the follower aircraft 16.

For example: a flight going from Paris CDG to Los Angeles LAX and another one going from Frankfurt FRA to San Francisco SFO often have their planned routes overlapping each other, merging together above British airspace, and splitting over American airspace. Between the merge point 22 and the split point 24 is the common ground track section 26 where a formation flight 20 may be considered according to the present processes.

The present processes also contemplate that the flights may be planning to depart from the same airport and/or heading to the same destination airport. For example: two aircraft departing from Los Angeles LAX airport, one going to Sydney and the other to Melbourne, often happen to share a common ground track going from the departure airport to a splitting point somewhere off the eastern coast of Australia. The same logic applies the other way on their flights back to LAX.

For cases where both aircraft 14, 16 depart from the same airport, the merge point 22 is one of the first common waypoints where both aircraft 14, 16 have completed the initial climb phase of their flight plans 10, 12. When both aircraft 14, 16 are heading to the same destination airport, the split point 24 is one of the last common waypoints through which the two aircraft 14, 16 fly before either of the aircraft 14, 16 initiates the final descent phase of their flight plans 10, 12.

In either case, according to the present processes, the leader aircraft 14 does not change its flight plan 10. Additionally, in the case of a formation flight 20 taking place over the common section 26, according to one embodiment, the waypoints indicated in the original flight plan of the follower aircraft 16 will not be changed for merging and flying with the leader aircraft 14. Rather, only the time of reaching these waypoints, altitudes, and speeds will be changed. Thus, implementing the formation flight 20 requires the follower aircraft 16, to accelerate or decelerate in flight, in order to close the gap with the leader aircraft 14 and then mimic the speed and altitude profile of the leader aircraft 14 while flying in a fuel saving formation, all through the common section 26. “Close the gap” means, for instance, that the follower aircraft 16 gets into a 3 NM position behind the leader aircraft 14 in order to take advantage of energy of the vortices.

Turning to FIG. 2, an exemplary process 100 according to the present invention describes how to determine if two aircraft 14, 16 may utilize a formation flight 20 in order to reduce fuel consumption.

Flight Plans Database for Future Flights

The present processes 100 rely on data in a database of future flights 102. The database of future flights 102 includes the flight plans of commercial aircraft.

Each flight plan is assigned a flight number and includes information such as the type of aircraft that will be making the flight. The flight plan also includes the requested waypoints to fly through, and for each of these waypoints, the associated speed, time of passage, and desired altitude of the aircraft at these waypoints.

Coarse Filtering

Accordingly, the process 100 includes a coarse filtering step 104 which filters the large number of flight plans in the database 102 and so the even larger number of potential leader-follower combinations by keeping only a limited number of possible follower-leader pairs 106 satisfying specified first filtering criteria 108. It should be appreciated that the terms “follower” and “leader” are in relation to the common ground track section 26 and that these terms are arbitrarily utilized when subjecting a pair to coarse filtering 104.

Generally, the present processes 100 include evaluating the operational feasibility of each candidate pair against the first, or course, filtering criteria 108. The coarse filtering criteria 108 may include: during a certain time period both aircraft of a potential pair must be airborne; the pair should have overlapping routes for a significant part of the flight; the two aircraft must not be flying further than 300 NM apart at the beginning of their overlapping route section. If the pair meets the first criteria 108, the process proceeds 100 with a fine filtering step 110 for each possible pair 106.

Calculation Module: Determination of the Pairs of Interest (Fine Filtering):

In the fine filtering step 110 of the process 100, for each possible pair of flights 106, the process 100 analyzes whether a modification of the flight plan of the follower aircraft to fly in formation with the leader over the common ground track section can generate trip (i.e., entire flight) fuel burn savings for the follower aircraft. If there is a benefit, it is considered to be a pair of interest 112. In this embodiment of the invention, only the speed and altitude profile of the follower aircraft is modified—compared to its initial flight plan. Therefore, the time at which the follower aircraft reaches each waypoint of the initially planned route may be impacted but not the route itself.

In the fine filtering step 110, all phases of the flight for both the leader aircraft and the follower aircraft from their respective departure to the arrival airports are simulated. The phases of the flight include taxi, takeoff, climb, cruise, descent, possible holding, final approach, and landing. By using each aircraft's associated flight performance, fuel consumption models, and data, the weight of each aircraft throughout its respective flight may be determined. FIG. 3 depicts an embodiment of the fine filtering step 110.

As shown in FIG. 3, the fine filtering step 110 includes determining the takeoff weights 200 for both aircraft in the possible follower-leader pairs 106. The takeoff weights may be communicated by the airlines. For example, the takeoff weights may be in the database 102 (FIG. 2). If takeoff weights for one or both aircraft are not available, they may be estimated for a given flight by knowing the weight characteristics of the aircraft, the length of the flights through the waypoints listed in the flight plans, and considering reasonable passenger load factors, i.e. cabin filling rate, e.g. 80%. Alternatively, these weights could be estimated through a statistical study of historical flights, by studying the recorded flight profiles from previous flights and comparing them to the performance capabilities for different weights of the given aircraft types. These estimates are sufficient for identifying candidates. The database may later on be updated with correction factors which will be adjusted as a historical database of formation flights is filled with the actual fuel savings reported.

Continuing on in FIG. 3, the fine filtering step 110 also includes a step 202 of determining the leading aircraft's weight throughout its unchanged initial flight plan. The weight of the leading aircraft is an important factor in determining the wake circulation's strength of the generated wake vortex—which has a direct impact on the follower aircraft's fuel savings.

For this step 202, the different phases of flight of the leader aircraft need to be simulated. Specifically, using performance models data and knowing the takeoff weight determined in step 200, the fuel burn value of the aircraft every step of the flight may be determined. Performance models provide data, for a given aircraft model, regarding fuel consumption, travelled distance and time needed for any given phase of flight, function of weight, altitude, speed, configuration of the aircraft, and International Standard Atmosphere (“ISA”) conditions. (ISA is a static atmospheric model of how the pressure, temperature, density, and viscosity of the Earth's atmosphere change over a wide range of altitudes or elevations.)

For simulating the cruise phase, the speed and altitude profile to fly must be determined all through this phase. Time and fuel consumption being closely related, choosing the right flight level and speed during cruise planning allows to minimize the Direct Operating Costs (DOC) of a flight. Optimization is done using a criteria called the specific range (SR). Expressed in NM/kg or NM/ton, it is the distance covered per fuel unit. This criteria depends on aerodynamic characteristics, engine performance, aircraft weight of the considered aircraft model as well as sound velocity at sea level, and evolves all through the flight. FIG. 4 illustrates the evolution of the SR criteria function of Mach number, for a given aircraft weight, aircraft configuration and a constant altitude.

As illustrated in FIG. 4, at any given weight and altitude, a maximum specific range value exists, and the corresponding Mach number is called Maximum Range Mach number (M_{MR}). This is the Mach number for which the fuel consumption for a given distance is at its minimum. It is therefore the maximum distance an aircraft can fly with a given fuel quantity. An alternative to M_{MR} is to increase slightly fuel consumption by a significant increase in cruise speed, allowing to get to the destination airport faster. The Long-range Cruise Mach number (M_{LRC}) provides that possibility: at this Mach the specific range corresponds to 99% of the maximum specific range.

An aircraft operator can decide to fly at either the M_{MR}, M_{LRC}, or even at an Economic Mach number (M_{ECON}), the latter taking into account all costs composing the DOC of a specific flight: fixed, flight-time related and fuel-consumption related costs. M_{ECON} allows therefore to fly while keeping the DOC to a minimum.

During cruise, an aircraft's weight decreases as it burns off fuel. The effect of this weight loss is illustrated in FIG. 5 which plots the SR function of Mach for different weights of a given aircraft, at a given altitude. As can be appreciated, the maximum SR value increases but the M_{MR} decreases.

Whatever the Mach optimization scheme an aircraft operator decides to follow, the optimum Mach number, as shown, would change all through the flight as the weight changes. The aircraft operator might even choose to follow a constant Mach number during the entire cruise phase of a flight. In that case, as the aircraft weight changes, the gap between the selected Mach and whichever optimum Mach evolves too.

Cruise planning also involves optimizing the flown flight levels of a flight. This is also done using the SR criteria. FIG. 6 illustrates, for a given Mach number, the impact of Pressure Altitude (PA) on the SR curve and the evolution of the maximum SR value and the corresponding PA for a given aircraft, as it burns off fuel and loses weight. PA is the altitude in the ISA with the same atmospheric pressure as that of the part of the atmosphere in question.

Thus, for a given weight, there exists an altitude where SR is at a maximum. This is the altitude that minimizes the aircraft's fuel consumption. This fuel optimum altitude increases continuously in flight as the aircraft's weight decreases. This evolution is illustrated in FIG. 7.

For ensuring a safe and organized air traffic, an aircraft cannot follow perfectly its continuously evolving optimum altitude throughout a flight, but rather fly at standard Flight Levels, performing step climbs to get from one to another. The aircraft has to try flying at flight levels as close as possible to its optimum altitude. The altitude profile of an aircraft using standard flight levels over a flight duration is illustrated in FIG. 8.

Planning the cruise phase of a flight demands a continuous and iterative analysis of the SR value over the available range of Mach numbers and Flight levels to look for the desired optimum. That is why the calculation is done iteratively in the simulation process, on sectors of flight of a few minutes (1 to 5 min) Having it recalculated consecutively on short sectors allows for altitude and speed to be optimized when needed and the mass of the aircraft to be updated all through the cruise phase, and all through the flight, by subtracting the burnt fuel mass using data given by the performance models. The process is able to obtain a table of the aircraft weight all through the flight, function of the distance traveled and time of flight since takeoff. This table also contains the optimized altitude and speed at every calculated point.

An exemplary with the tabulated calculated data is depicted below in TABLE 1.

TABLE 1

| | Distance | Time | Altitude | | Mass |
|---|---|---|---|---|---|
| | (Nm) | (h) | (ft) | Mach | (kg) |
| Departure airport | 0 | 0 | 0 | 0 | 235000 |
| . . . | . . . | . . . | . . . | . . . | . . . |
| 23 | 227.072 | 0.5460 | 38000 | 0.84 | 230000 |
| 24 | 235.102 | 0.5627 | 38000 | 0.84 | 229903 |
| 25 | 243.132 | 0.5793 | 38000 | 0.84 | 229807 |
| 26 | 251.162 | 0.5960 | 38000 | 0.84 | 229710 |
| 27 | 259.192 | 0.6127 | 38000 | 0.84 | 229613 |
| 28 | 267.222 | 0.6293 | 38000 | 0.84 | 229517 |
| 29 | 275.252 | 0.6460 | 38000 | 0.84 | 229420 |
| 30 | 283.282 | 0.6627 | 38000 | 0.84 | 229323 |
| 31 | 291.312 | 0.6793 | 38000 | 0.84 | 229227 |
| . . . | . . . | . . . | . . . | . . . | . . . |
| Destination airport | 4000.000 | 9.0000 | 0 | 0 | 195000 |

In the above TABLE 1, the numbers in the first column represent calculation points in the flight simulation process.

Returning to FIG. 3, the fine filtering step 110 also includes a step of determining the follower aircraft's weight throughout its unchanged initial flight plan 204. This step 204 may follow the exact same procedure as for the leader aircraft to tabulate the evolution of the follower aircraft's mass, Mach value and altitude throughout its unchanged initial flight plan (not including any formation section) function of the distance traveled and time of flight since takeoff. This will be needed for determining the reference trip fuel consumption, and later on the fuel savings achievable with formation flight, discussed below.

Next, the fine filtering step 110 determines a new flight plan for the follower aircraft and the weight of the follower aircraft along its new flight plan 206.

In this step 206, the previous process of simulating the different phases of the follower's flight is repeated. The difference in this case is that the process 100 simulates getting the follower aircraft within a, for instance, 3 NM distance behind the leader aircraft. This formation position is to be acquired as close as possible to the previously described merge point 22. See, FIG. 1. Moreover, the process takes into account in the simulation the effect of flying in the upwash region of the trailing vortices of the leader aircraft for the rest of the common section.

The follower aircraft 16 has two options to close the gap and place itself within the 3 NM behind the leader aircraft 14. If it is behind the leader, it has to speed up if at cruising altitude, or even perform a faster initial climb if appropriate/needed. If it is ahead, it can perform a slower initial climb and/or slow down when at cruising altitude, fall back and allow the leader to naturally catch up.

Once the follower aircraft 16 is within the 3 NM behind the leader aircraft 14, the follower aircraft 16 needs to adapt its speed and altitude to the speed and altitude of the leader aircraft 14 at that point of the flight and for the rest of the common section 26 until the pair reaches the split point 24. See, FIG. 1. The flight profile (speed and altitude) data of the leader aircraft 14 has been calculated and tabulated in step 202. Between the point where the follower aircraft 16 gets into position, which may or may not be the merge point, and the split point 24, the process simulates the follower aircraft 16 flight while taking into account the benefit of flying in the wake upwash region.

As explained previously, the formation flight 20 is performed over a part of the cruise phases of both flights 10, 12. This part, calculated iteratively for consecutive sectors of a few minutes of flight, uses fuel burn data from the performance models to update the mass of the follower aircraft 16 as it travels along its flight plan. One way to add the formation flight fuel saving benefit for the follower aircraft 16 in the simulation is by intervening on the FC fuel consumption data given by the original performance models for the aircraft (not in formation) at any given instant (given weight, configuration, speed, altitude, ISA conditions, . . . ), i.e. by adding the associated ΔFC fuel consumption reduction term calculated by multiplying four quantities such that:

ΔFC=kADJ·kFC·kWD·kWS·FWV(ΔY) [Equation 1].

In Equation 1, FWV(ΔY) represents the aerodynamic benefits determined from the aerodynamic influence of the wake vortices integrated over the wingspan of the follower aircraft 16. The primary input variable for this term is the lateral separation from the wake vortices AY. The wake vortex spacing and vortex core radius are parameters for a model for the radial velocity of the vortices, which varies with the distance from the vortex cores. The separation from the wake, AY, positions the follower aircraft relative to the wake vortices at the same altitude. The influence of the wake is then related to a distribution of upwash on the wing, which may be used to determine an approximate lift increase through a weighting function determined from the wing loading.

The term kWS from Equation 1 represents the initial wake circulation strength calculated from the estimated mass and speed of the leading aircraft, the local gravitational acceleration, the air density at the current altitude and temperature, and the true airspeed of the leader.

From Equation 1, kWD represents an estimate of the fraction of the wake strength decay based on the age of the vortex, which is determined from the speed of the following aircraft and the relative distance between the leader and follower while in formation.

The term kFC in Equation 1 represents a coefficient needed to obtain the predicted reduction in fuel consumption from the combined aerodynamic performance improvements obtained from multiplying terms 1 through 3. This term uses the following parameters known or estimated for the follower aircraft: specific range, specific fuel consumption, true airspeed and mass.

Finally, kADJ in Equation 1 is used to correct the predicted reduction in fuel consumption based on data obtained from previous flights for the same or similar aircraft type in a fuel saving formation. This adjustment may be improved over time as more data is available from actual flights.

Once the aircraft 14, 16 have reached the split point 24, the step 206 simulates what is left of the flight of the follower aircraft 16 from that point, thus using the resulting new mass at that point, to its destination airport, using the original performance models. Accordingly, the step 206 simulates what is left of the cruise sector, the descent phase, possible holding and finally the final approach and landing phase, calculating the mass evolution at every step.

As the fuel burn of the follower aircraft 16 is modified all through the formation flight sector compared to its initial unchanged flight simulated from step 204, its weight also evolves differently. Therefore, the aircraft has a different weight at arrival than in the original flight plan.

Finally, the fine filtering step 110 also includes a step of comparing the trip fuel consumption flying the new flight plan with that of flying the initial flight plan 208.

Accordingly, the step 208 may calculate the difference of: [mass at landing—the takeoff mass with the flight plan including a formation flight] minus [mass at landing—the takeoff mass for the initial unchanged flight plan not including a formation flight]. If there is a gain, the pair is selected as a pair of interest 112 (see, FIG. 2), otherwise it is rejected.

The follower aircraft might not always be able to fly with the leader aircraft as the accessible altitudes and speeds, regarding performance capabilities, depend on the aircraft model, weight, configuration and ISA conditions. The flyable domain of speeds and altitudes is called the speed envelope of an aircraft. Various phenomena draw the limits of this speed envelope such as buffet, air compressibility effect, structural flutter, structural loads, stall and engine capabilities.

These constraints of speed and/or altitude may be a second criteria 114 used in the fine filtering step 110. They apply to every step of a flight and should be verified continuously when simulating a flight of any aircraft. Thus, the second criteria 114 may be verified continuously not only in steps 202 and 204, but also continuously in step 206. This second criteria may be particularly constraining when the process simulates the follower aircraft 16 closing the gap with the leader aircraft 14 in order to place itself in the, for instance, 3 NM fuel saving formation position behind the leader aircraft 14, and then from that point of the flight and for the rest of the common ground section 26, when attempting to adapt its speed and altitude to the speed and altitude of the leader aircraft 14. If the altitude and speed of the leader aircraft 14 is outside of the speed envelope of the follower aircraft 16, then it is not possible for them to form a formation at that point of the flight. This constraint has to be verified all through the flight and may be a second criteria 114 used in the fine filtering step 110. If the formation is never possible in the common route section due to the second criteria 114, then the pair is not selected as a pair of interest.

In the case where it is possible for part of the common section 26, the process may include simulating the follower's full flight with the formation fuel burn adjustment solely over the part in question (after which the formation would break and the follower would complete his flight to his destination airport as a normal flight, simulated using the original performance models), and compare the final trip fuel consumption with the one obtained for the unchanged initial flight plan. If there are fuel savings, then the pair is selected as a pair of interest, otherwise it is rejected. However, due to the speed envelope constraints, a follower aircraft might also not be able to close the gap with the leader aircraft and place itself in the 3 NM distance behind the leader. In this case, the pair will not be selected as a pair of interest 112 because of the second criteria 114.

At the end of the process 100, if there are one or several possible pairs of interests for a given flight, the process 100 includes a step 116 of providing the new flight plan options for that flight with the respective calculated fuel burn savings to the airlines or other appropriate authority. This step 116 may allow the airline to select 118, via a man-machine interface, a pair of interest and to update 120 the flight plan of the follower aircraft in the database 102. Alternatively, if presented with one or several pairs of interest, the process 100 may automatically select 118 the combination of pairs of interest that offers the highest accumulated follower trip fuel savings possible, while satisfying aircraft operator's preselected preferences and Air Traffic Control (ATC) constraints that have been indicated or provided. The flight plan is updated with the airline and presented for validation to the authorities (including ATC) and may be updated in the database 102.

As explained above, the foregoing embodiment of the present process 100, the waypoints of the flight plan for the follower aircraft were not adjusted—only the time to reach these waypoints, altitudes, and speeds are changed. However, in another embodiment, the present process 100′ includes modifying the initial flight plan of the follower aircraft with new waypoints to go through during its flight.

In this embodiment, for each possible pair of flights, the process 100′ will modify the flight plan of the follower aircraft by simulating earlier merge points and later spilt points with the flight plan 10 of the leader aircraft 14, so as to have a common route 26 section longer than the one found in the original flight plans. Thus, the process 100′ analyzes whether flying in a fuel saving formation on the extended common section generates trip fuel burn savings for the follower aircraft compared to flying the initial flight plan. If there is a benefit, it is considered to be a pair of interest 112. Accordingly, the speed and altitude profile of the follower aircraft is also modified compared to its initial flight plan and the flight plan of the leader aircraft is again not modified.

Referring to FIG. 2, in this embodiment of the present invention, the process 100′ includes a coarse filtering step 104 based on the large number of aircraft referenced in the database 102. In the coarse filtering step 104, the operational feasibility of each candidate pair is again evaluated against the first criteria 108′. If the pair meets the criteria 108′, the process 100′ proceeds with evaluation of the possible pair 106.

According to this embodiment, the first criteria 108′ may include:

during a certain time period both aircraft of a potential pair must be airborne;

general direction (example: from south to north, from east to west) which is similar/identical for the two planes of a possible pair;

maximum allowable added travel distance of 700 NM: for a candidate pair of aircraft composed of the follower and a leader, this is the maximum extra travel distance that can be imposed (between the beginning and the end of the follower aircraft's flight) upon the follower aircraft with respect to its initial route so that the latter is positioned in a situation of formation flight engagement, i.e. under a distance of, for instance, 3 NM behind the leader (the maximum added travel distance corresponds to the maximum distances that would have to be traveled to cancel the maximum gain of the possible pairs); and,

the two aircraft must not be flying further than, for instance, 300 NM (included in the 700 NM limit mentioned above) apart at the beginning of their overlapping route section, before applying any catching up strategy, whether their route's merge point is resulting from their original flight plans or the modified one.

As an example of the added travel distance limit, a first aircraft following a second aircraft on a very long-haul flight can generate up to 8 tons of fuel gain. Using an average fuel consumption value, it is estimated that it would take a little less than 700 NM in solo flight for the first aircraft to consume 8 tons of fuel. Thus, a detour of more than 700 NM cannot be imposed to the follower aircraft to join the formation.

Additionally, it should be noted that in this embodiment, the first criteria 108′ may not necessarily include or require that the pair initially has a common ground section.

As shown in FIG. 2, as in the case of the above embodiment, in this embodiment, the process 100′ includes a fine filtering step 110′ in which all phases of a flight for both leader and follower aircraft from their respective departure to arrival airport are simulated. Again, the phases are: taxi, takeoff, climb, cruise, descent, possible holding, final approach and landing. By using the two aircraft's associated flight performance and fuel consumption models and data, the process may determine each of the aircraft's weights throughout their respective flight.

Turning to FIG. 9, the fine filtering step 110′ of the present embodiment includes the same initial steps 200, 202, and 204 discussed above with respect to FIG. 3.

The fine filtering step 110′ of the present embodiment also includes a step of determining a new flight plan for the follower aircraft and the weight of the follower aircraft along its new flight plan 206′, however in this embodiment one or both of the merge and split points of each possible follower-leader pairs 106 is updated/modified (or even created when non-existent).

Accordingly, in this step 206′, for identifying a new merge and/or split waypoint, the fine filtering step 110′ considers waypoints on the flight plan 10 of the leader aircraft 14 outside of the initially identified, if existing, common route section 26. The step 206′ may determine waypoints that are the ones that allow the follower aircraft 16 to maximize its trip fuel savings. There exists many optimal path searching algorithms and techniques with various performance and complexity. For example, one way exploited in step 206′ to determine the new merge and/or split waypoint is by using an average fuel consumption rate determined from the simulated flights following the unchanged initial flight plan, and an average formation flight potential fuel consumption reduction value. Using average values allows the fine filtering step 110′ to process faster the large quantity of possible follower-leader pairs 106 to test, by making the calculations easier and faster.

In order to orient the search and reduce the number of potential waypoints to evaluate when searching for the new merge waypoint, one way the step 206′ uses a heuristic technique, for example, is by applying the above mentioned average fuel consumption values to great circle distances between the follower aircraft (either from its departure airport or a desired point in flight) and potential merge waypoints, and the average fuel consumption with the formation flight reduction to the consequently added segment of common route. Then for each of the potential merge waypoints left, the step 206′ calculates the shortest path (ground distance or Equivalent Still Air Distance) through available airways and waypoints, linking the original route to the tested merge waypoint. It then applies the average fuel consumption values to the calculated new route and added segment of common route (flown information), in order to determine the fuel cost of each considered merge waypoint. It then compares the results: the new merge waypoint is identified as the one allowing the lowest fuel consumption for the follower aircraft.

The same evaluation applies when searching for the optimal split point. The step 206′ first uses a heuristic technique to orient the search and reduce the number of potential split waypoints by applying average fuel consumption values with formation flight reduction to the added segment of common route, and average values without the fuel consumption reduction for the aircraft flying alone to the great circle distances between the considered split waypoints and the follower aircraft's destination airport. It then identifies the shortest paths, through available airways and waypoints, linking the remaining potential split waypoints to the destination airport and applies the average fuel consumption values to them. The new split waypoint is identified as the one allowing the lowest fuel consumption for the follower aircraft.

The new route should satisfy air traffic constraints and airline preferences. The result gives at least one possible route for the follower aircraft. Of course, the optimized merge and/or split waypoints may turn out to be the original merge and/or split waypoints, before altering or modifying the flight plan of the follower aircraft.

Then the step 206′ determines the weight of the follower aircraft along its new flight plan. Again, this is determined following the process explained above by: simulating the different phases of the flight; simulating closing the gap between the pair to get the follower in the, for instance, required 3 NM distance behind the leader; adapting the follower aircraft's speed and altitude profile to the leader's for the section between the point where the follower gets into position and the (possibly new) split point; applying the associated fuel consumption reduction term ΔFC in the iterative calculation of sectors of a few minutes (1 to 5 min) of the formation flight segment; simulating what is left of the follower aircraft's flight after the split of the formation to its destination airport, using the original performance models.

As for the foregoing embodiment, the present embodiment also includes a step 208 of comparing the trip fuel consumption flying the new flight plan with that of flying the initial flight plan.

Returning to FIG. 2, if there is a saving of fuel, the pair is selected as a pair of interest 112, otherwise it is rejected. Additionally, as explained above, speed envelope constraints (as second criteria 114) must be verified continuously in the fine filtering 110′ as they might limit the follower in flying in a fuel saving formation with the leader over part or over the whole new common section, or even make closing the gap with the leader impossible.

It is contemplated that the fine filtering 110′ also includes a step of optimizing of the new route of the follower aircraft when having used average fuel consumption values is step 206′, by testing surrounding waypoints on the leader aircraft's route as new merge/split waypoints: steps 206′ and 208 are repeated while using the actual performance models this time on the identified respective shortest path (ground distance or Equivalent Still Air Distance) instead of the fuel consumption averages. This allows a finer determination of the fuel cost of each of these route modifications. Comparing the results provides the optimal merge and/or split waypoint, generating the highest trip fuel savings for the follower aircraft. Completing this when a pair is identified as a pair of interest 112 allows the process to run faster by completing it on fewer number of pairs, but it is contemplated that this step can be completed for every pair 106 before evaluating in step 208 if a pair in question is a pair of interest.

The remaining portions of this process 100′ are the same as described above.

This embodiment makes it possible to optimize the flight plan of the follower aircraft in order to provide a common section which increases or even maximizes the trip fuel savings of the follower aircraft with a redefinition of the merge waypoint and/or split waypoint on the flight plan of the leader aircraft, in the case where the leader and follower have a common route section in their original unchanged flight plan, or by calculating a new route for the follower aircraft with a merge waypoint, common section, and a split waypoint in the case where the leader and follower do not have overlapping routes in their initial flight plans, thus with no common section.

According to this embodiment, it is contemplated that only the split waypoint is modified. The follower aircraft saves fuel by flying in formation with the leader aircraft over the common section identified in their original flight plan. Instead of splitting from the leader at the original split waypoint, the follower aircraft follows the leader on his route still flying in formation and saving fuel. Once they get to the previously calculated new split waypoint, the formation breaks and the follower flies to its destination airport.

Alternatively, only the merge waypoint or both the merge waypoint and split waypoint are modified. Thus, the follower aircraft takes off and leaves its originally planned route to merge with the leader aircraft at the modified/amended/updated merge waypoint. Modifying the merge waypoint opens the possibilities of pairs of interest to pairs of aircraft not having overlapping routes in their original flight plans. The pair flies in formation until they reach the modified split point where the formation breaks, and the follower aircraft flies to its destination airport.

Not only does the present embodiment allow to maximize follower fuel savings and enable formation flight between pairs not having overlapping routes in their original flight plans, but it could also help in closing the gap between leader and follower aircraft and get the latter into the fuel saving formation position in an easier and less fuel consuming way.

By flying at speed and altitude of the leader aircraft, the follower aircraft will most likely arrive at its destination airport ahead of or behind schedule compared to the original flight plan. When required, the process 100, 100′ compensates by having the follower aircraft speed up or slowdown in the simulation, after the split of the formation with the leader aircraft. In the case of the advanced embodiment, when optimizing the split point, this could be taken into account and the split point can be chosen as a compromise between fuel savings and arrival time impact.

Additionally, identifying pairs of interest in the coarse filter step 104 could be rendered more precise and reliable by analyzing flight history data, with or without formation flight, tracks flown, weather history and future predictions, schedules and delay statistics, rerouting occurrences, etc. Further, the first criteria 108, 108′ may include: types of aircraft; same airline/or other airline with which an agreement has been reached (flying into formation may require the leader's pilots to follow special procedures, including for communications); airline preferences for pairing choices; and, air traffic management constraints on certain regions might affect the pairing possibilities.

For a given aircraft pair, if both aircraft have the capability of playing the leader and the follower role, both leader-follower combinations may be tested. A pair could be a possible pair 106 or a pair of interest 112 in one leader-follower combination and not in the other. It may also generate fuel savings in both combinations. In that case, the processes 100, 100′ have a choice when assigning the roles in step 116.

A large-scale optimization of departure schedules could allow maximizing the fuel savings of a whole fleet or even of the entire aviation industry. Adapting schedules would facilitate closing gaps between the leader and the follower aircraft of a given pair and even allow to decide the combinations of flights to be paired together, and so enable setting up the most profitable combinations of aircraft models to fly together in formation. Moreover, adapting takeoff schedules would allow for minimizing distances between leader and follower aircraft of a given pair, and so minimize the effort of closing the gap and getting into the formation flight position. This potential large-scale optimization would of course need to satisfy airline preferences and flexibility, and air traffic constraints as well.

As commercial aircraft generate two trailing wake vortices, it is contemplated to have an aircraft behind on either one of the two upwash regions. It is also contemplated to have a leader aircraft followed by a second aircraft which is also playing the leader role for a third following aircraft. Following this logic, it is contemplated to provide large groups of aircraft flying information. For the sake of simplicity, the present disclosure has considered only a pair of two aircraft, a leader and a follower, but the process explained supra applies for any pair of neighboring aircraft in a formation of a larger number.

The different embodiments of the present invention described above include modifying existing flight plans for the follower aircraft included in a database of future flights. Nevertheless, it should be understood that the described embodiments of the process contain all the steps needed not only to modify existing flight plans, but also to create new flight plans if needed for a follower aircraft.

Accordingly, it is possible, with present processes, to identify a pair of aircraft of interest from a database of future flights, without including the associated flight plans of the flights. A flight typically includes an identified aircraft type and airline, an identified departure and destination airport, and an identified time of departure and time of arrival. The present processes may create an initial flight plan for the follower aircraft that does not including the fuel saving formation flight operation for a given pair of flights identified in the database. The process may then create a new flight plan for the follower aircraft which includes flying in the upwash of the leader aircraft's wake vortices and saving fuel, before finally, determining if there is a trip fuel savings for the follower aircraft. The created initial flight plan used in the coarse filtering step using criteria 108, 108′ may be based on past flight plans or even recorded past flights (instead of future flight plans). Using historical flight data would allow the process to do a coarse filtering step of a large number of future flights. After comparing the created initial flight plan and the created new flight plan, the process may update the database of flights with the new flight plan of the follower aircraft if there is a trip fuel savings.

It is also further contemplated that the coarse filtering criteria could be based on a history of pairs which are known to be of interest once the fuel saving flight formation operations have gained maturity and become usual, and airlines are confident with the quality and benefit of the pairs of interest provided by the present processes.

Accordingly, the process would not require using or creating an initial flight plan of the follower aircraft, both historical and of future flights. Rather, for a given pair of flights identified in the database, having an initial flight plan of the leader aircraft in the database or creating it if not the case (as described above for creating an initial flight plan for the follower aircraft), the processes would directly create the flight plan of the associated follower aircraft wherein the flight plan of the follower aircraft includes a common ground section which overlaps with the initial flight plan of the leader aircraft so that the follower aircraft is flying in an upwash region of the leader aircraft's wake vortices and saving fuel. The process would then update the database of flights with the new flight plan of the follower aircraft.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CD-ROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A process for pairing two aircraft together to save fuel by adjusting a flight plan of one of the two aircraft, the process comprising:
identifying a possible pair of aircraft from a database of aircraft flight plans, the possible pair of aircraft including a leader aircraft and a follower aircraft, each aircraft having an initial flight plan;
modifying the initial flight plan of the follower aircraft to provide a new flight plan, wherein the new flight plan includes a common ground section which overlaps with the initial flight plan of the leader aircraft so that the follower aircraft flies in an upwash region of wake vortices of the leader aircraft;
determining if there is a trip fuel savings associated with the possible pair of aircraft based on the follower aircraft utilizing the new flight plan instead of the initial flight plan; and,
when there is a trip fuel savings, replacing the initial flight plan in the database with the new flight plan.

2. The process of claim 1, wherein identifying a possible pair of aircraft from a database of aircraft flight plans comprises:
applying a first criteria to the database of aircraft flight plans to provide the possible pair of aircraft.

3. The process of claim 2, wherein the first criteria comprise:
determining that the leader aircraft and the follower aircraft are both airborne at the same time for a certain time period; or,
determining that the initial flight plan of the leader aircraft and the initial flight plan of the follower aircraft have an overlapping section; or,
determining that the initial flight plan of the leader aircraft and the initial flight plan of the follower aircraft have an overlapping section and that the two aircraft are not further than 300 NM apart at a beginning of the overlapping section; or,
a combination thereof.

4. The process of claim 2, wherein the first criteria comprise:
determining that the leader aircraft and the follower aircraft are both airborne at the same time for a certain time period; or,
determining that the initial flight plan of the leader aircraft and the initial flight plan of the follower aircraft have the same general direction; or,
determining that a maximum allowable added travel distance of 700 NM for the follower aircraft is not exceeded; or
determining that the two aircraft are not further than 300 NM apart at a beginning of the overlapping section, whether the overlapping section is resulting from the follower aircraft's initial flight plan or the new flight plan; or
a combination thereof.

5. The process of claim 2, wherein the first criteria comprise:
types of the leader aircraft and the follower aircraft; or,
airlines of the leader aircraft and the follower aircraft; or,
airline preferences for pairing choices; or,
a combination thereof.

6. The process of claim 1, wherein modifying the flight plan of the follower aircraft to provide a new flight plan comprises:
adjusting a speed, an altitude, or both to reach a point in a fuel savings formation.

7. The process of claim 1, wherein modifying the flight plan of the follower aircraft to provide a new flight plan comprises:
adjusting a speed, an altitude, or both to fly at the speed and altitude of the leader aircraft from the merge to the split point.

8. The process of claim 1, wherein modifying the flight plan of the follower aircraft to provide a new flight plan comprises:
adjusting a merge point, a split point, or both, the merge point representing an initial waypoint in the common ground section and the split point representing a final waypoint in the common ground section.

9. The process of claim 1, wherein determining if there is a fuel savings associated with the possible pair of aircraft comprises:
determining takeoff weights of both the follower aircraft and the leader aircraft;
determining a weight of the leader aircraft throughout the initial flight plan of the leader aircraft;
determining a weight of the follower aircraft throughout the initial flight plan of the follower aircraft; and,
determining a weight of the follower aircraft throughout the new flight plan.

10. The process of claim 1, further comprising:
continuously applying a second criteria between the merge and the split point and then if the second criteria is satisfied and there is a trip fuel savings, replacing the initial flight plan in the database with the new flight plan.

11. The process of claim 10, wherein the second criteria comprise:
continuously comparing a speed envelope of the leader aircraft with a speed envelope of the follower aircraft making sure that any given Mach number and/or altitude the follower aircraft and the leader aircraft fly at together is compatible with the respective speed envelopes.

12. The process of claim 1, wherein the database is updated automatically based on a preselected preference.

13. A process for pairing two aircraft together to save fuel by adjusting a flight plan of one of the two aircraft, the process comprising:
identifying a possible pair of aircraft from a database of aircraft flight plans, the possible pair of aircraft including a leader aircraft and a follower aircraft, each aircraft having an initial flight plan, and each initial flight plan having a plurality of waypoints along the flight plan;
modifying the initial flight plan of the follower aircraft to provide a new flight plan, wherein the new flight plan includes a common ground section which overlaps with the initial flight plan of the leader aircraft so that the follower aircraft flies in an upwash region of wake vortices of the leader aircraft, and wherein the new flight plan includes the same waypoints as the initial flight plan of the follower aircraft;
determining if there is a trip fuel savings associated with the possible pair of aircraft based on the follower aircraft utilizing the new flight plan instead of the initial flight plan; and,
when there is a trip fuel savings, replacing the initial flight plan in the database with the new flight plan.

14. The process of claim 13, wherein the new flight plan includes at least one new waypoint that is not in the initial flight plan of the follower aircraft.

15. The process of claim 14, wherein the common ground section includes a merge point at a beginning and a split point at an end, and
wherein the merge point is based on a new waypoint from the at least one new waypoint that is not in the initial flight plan of the follower aircraft.

16. The process of claim 14, wherein the common ground section includes a merge point at a beginning and a split point at an end, and
wherein the split point is based on a new waypoint from the at least one new waypoint that is not in the initial flight plan of the follower aircraft.

17. The process of claim 14, wherein the common ground section includes a merge point at a beginning and a split point at an end,
wherein the split point is based on a first new waypoint from the at least one new waypoint that is not in the initial flight plan of the follower aircraft, and
wherein the merge point is based on a second new waypoint from the at least one new waypoint that is not in the initial flight plan of the follower aircraft.

18. A process for pairing two aircraft together to save fuel by creating a flight plan of one of the two aircraft, the process comprising:
identifying a possible pair of aircraft from a database of flights, the possible pair of aircraft including a leader aircraft and a follower aircraft, the leader aircraft having an initial flight plan;
creating an initial flight plan of the follower aircraft;
creating a new flight plan of the follower aircraft, wherein the new flight plan of the follower aircraft includes a common ground section which overlaps with the initial flight plan of the leader aircraft so that the follower aircraft flies in an upwash region of wake of the leader aircraft;
determining if there is a trip fuel savings associated with the possible pair of aircraft based on the follower aircraft utilizing the new flight plan instead of the initial flight plan; and,
when there is a trip fuel savings, updating the database of flights with the new flight plan of the follower aircraft.

19. The process of claim 18, wherein the initial flight plan of the follower aircraft is based on a past flight plan or a past flight.
